(19) United States
(12) Patent Application Publication
(10) Pub. No.: US 2011/0240203 A1
(43) Pub. Date: Oct. 6, 2011

(54) METHOD FOR PRODUCING A MEMBRANE-ELECTRODE ASSEMBLY FOR A FUEL CELL

(75) Inventors: Eun Ae CHO, Seoul (KR); Hyun-Sook Jang, Seoul (KR); Tae Hoon Lim, Seoul (KR); In Hwan Oh, Seoul (KR); Suk-Woo Nam, Seoul (KR); Hyoung-Juhn Kim, Suwon-si (KR); Jong Hyun Jang, Yongin-si (KR); Soo-Kil Kim, Seoul (KR)

(73) Assignee: Korea Institute of Science & Technology, Seoul (KR)

(21) Appl. No.: 13/154,214

(22) Filed: Jun. 6, 2011

Related U.S. Application Data
(63) Continuation-in-part of application No. 13/074,827, filed on Mar. 29, 2011.

(30) Foreign Application Priority Data
Apr. 1, 2010 (KR) 10-2010-0030003

(51) Int. Cl. B32B 37/24

(52) U.S. Cl. 156/73.1

(57) ABSTRACT

Disclosed is a method for producing a membrane electrode assembly for a fuel cell, including: dispersing a catalyst and a conductive binder into a dispersion solvent to provide catalyst slurry; subjecting the catalyst slurry to stirring, sonication and homogenization; applying the catalyst slurry onto a substrate, followed by drying; transferring the substrate coated with the catalyst slurry to either surface or both surfaces of an electrolyte membrane to form a catalyst layer; dipping the substrate, the catalyst layer and the electrolyte membrane obtained after the preceding operation into liquid nitrogen; and removing the substrate to provide an electrolyte membrane having the catalyst layer formed thereon.

### CROSS-REFERENCE TO RELATED APPLICATION

This application is a Continuation-in-Part of U.S. patent application Ser. No. 13/074,827, filed 29 Mar. 2011, which claims the benefit of Korean Patent Application No. 10-2010-0030003, filed 1 Apr. 2010, and which applications are incorporated herein by reference. A claim of priority to all, to the extent appropriate is made.

### BACKGROUND

1. Field

The present disclosure relates to a method for producing a membrane-electrode assembly (MEA) for a fuel cell. More particularly, the present disclosure relates to a MEA for a fuel cell, which allows catalyst slurry including catalyst and conductive binder particles dispersed therein to have physical properties suitable for a MEA for a fuel cell so as to accomplish uniform application of catalyst slurry onto an electrolyte membrane and a high catalyst transfer yield.

2. Description of the Related Art

Fuel cells are electricity-generating systems by which chemical energy of hydrogen and oxygen contained in hydrocarbon materials, such as methanol, ethanol and natural gas, is converted directly into electric energy via electrochemical reactions.

As electronic industries have been developed rapidly, fuel cells have been regarded as one of the most adequate energy sources amenable to the current trend in popularization of portable and mobile electronic products, such as cellular phones, notebook computers and PDAs. While such portable electronic products have been popularized, batteries used as power sources for such products have not yet provided quality sufficient to meet the requirement of high functionalization. Moreover, such batteries are expensive and heavy.

Therefore, in order to meet such requirement, many studies have been made to develop small polymer electrolyte membrane fuel cells (referred to also as “PEMFC” hereinafter) or direct methanol fuel cells (referred to also as “DMFC” hereinafter).

In PEMFCs or DMFCs, their quality depends largely on the MEA. An MEA includes a solid polymer electrolyte membrane as an ion conducting membrane (ICM) and two catalyzed electrodes separated by the former. More particularly, carbon powder applied on a support layer, such as carbon cloth or carbon paper, forms a gas diffusion layer, and catalyst-supported carbon powder is applied onto the diffusion layer to form a catalyst layer.

To accomplish good quality in an MEA, dispersibility of a catalyst and a conductive binder having a diameter of 5-200 nm in a solvent is important. Once catalyst slurry is subjected to coating operation after dispersion, operation of hot pressing a catalyst layer to an electrolyte membrane determines the distribution and pore structure of a catalyst, which, in turn, determine paths through which hydrogen ions, electrons and water formed at a cathode layer are discharged. Such paths affect the quality of a fuel cell.

Thus, when a catalyst is not dispersed homogeneously and catalyst and conductive binder particles undergo agglomeration, the resultant fuel cell may not have improved quality. Accordingly, it is important to solve the above-mentioned problems occurring in producing an MEA and to provide catalyst slurry having adequate dispersibility.

### SUMMARY

The present disclosure is directed to providing a membrane-electrode assembly for a fuel cell, which provides improved dispersibility of catalyst and conductive binder particles and catalyst transfer yield through a transfer process to accomplish uniform particle distribution, and thus improves the quality of a fuel cell.

In one aspect, there is provided a method for producing a membrane-electrode assembly for a fuel cell, including:

dispersing a catalyst and a conductive binder into a dispersion solvent to provide catalyst slurry;

subjecting the catalyst slurry to stirring, sonication and homogenization;

applying the catalyst slurry onto a substrate, followed by drying; and

transferring the substrate coated with the catalyst slurry to either surface or both surfaces of an electrolyte membrane to form a catalyst layer.

According to an embodiment, the method may further include:

dipping the substrate, the catalyst layer and the electrolyte membrane obtained after the preceding operation into liquid nitrogen; and

removing the substrate to provide an electrolyte membrane having the catalyst layer formed thereon.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view showing the structure used in the method disclosed herein in accordance with an embodiment.

FIG. 2 is a graph showing the result of a test of viscosity of catalyst slurry in accordance with an embodiment.

FIG. 3 is a graph showing the results of measurement of the transfer yield of a unit cell obtained in according with an embodiment.

FIG. 4 is a graph showing the results of FT-IR analysis and ion conductivity measurement of an electrolyte membrane treated with liquid nitrogen.

FIG. 5 is a graph showing the performance of a unit cell obtained in accordance with an embodiment.

### DETAILED DESCRIPTION

Exemplary embodiments now will be described more fully hereinafter with reference to the accompanying drawing, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The method for producing a membrane-electrode assembly for a fuel cell disclosed herein includes dispersing a catalyst and a conductive binder into a dispersion solvent to provide catalyst slurry.

In one embodiment, the catalyst may be platinized carbon (Pt/C). Herein, Pt may be present in the catalyst in an amount of 40 to 50 wt %, but is not limited thereto.

The conductive binder that may be used herein includes Nafion ionomers (available from Dupont) based on perfluorosulfonic acid (PFSA) or polymer electrolyte ionomers based on hydrocarbons, but is not limited thereto.

Particular examples of the dispersion solvent may include at least one selected from the group consisting of isopropanol, n-propanol, ethanol, methanol, water and n-butyl acetate, but are not limited thereto.

If desired, the catalyst slurry may essentially include water to prevent combustion caused by abnormal reaction with the dispersion solvent due to high activity of the Pt catalyst in preparing the catalyst slurry. In this case, it is possible to ensure the stability of the catalyst slurry through the water introduced thereto.

There is no particular limitation in the amount of the catalyst, conductive binder and dispersion solvent contained in the catalyst slurry obtained as described above. However, in one exemplary embodiment, the catalyst slurry may include 3 to 10 wt % of catalyst, 1 to 5 wt % of conductive binder and 75 to 96 wt % of dispersion solvent based on the total amount of the catalyst slurry.

After providing the catalyst slurry as described hereinbefore, the catalyst slurry maintains a settled state, and thus hardly maintains a stably dispersed state. Therefore, the method disclosed herein includes subjecting the catalyst slurry to stirring, sonication and homogenization.

When the catalyst slurry is not in a stably dispersed state but in a settled state, the catalyst distribution is varied by such settling during the subsequent operation of coating or transferring to an electrolyte membrane, resulting in variations in amount and distribution of catalyst at different portions. In addition, settled particles may agglomerate to cause an inconsistent increase in viscosity. As a result, it is difficult to obtain stable physical properties.

However, it has been discovered and now revealed by the method disclosed herein that stirring the catalyst slurry provides a relatively narrow distribution of catalyst and conductive binder particles to prevent particle agglomeration and an inconsistent increase in slurry viscosity caused thereby. In this manner, it is possible to provide catalyst slurry maintaining a homogeneously dispersed state.

Any stirring systems may be used as long as they accomplish a desired effect. For example, magnetic stirrers (e.g.: Model name MS-300) may be used, particularly under a stirring speed of 500 to 1000 rpm, more specifically 800 rpm.

After carrying out the stirring operation, sonication and homogenization may be carried out by any processes generally known to those skilled in the art. In one exemplary embodiment, the catalyst slurry may be subjected to sonication for 25 to 30 minutes and may be homogenized for 110 to 120 minutes by using a homogenizer.

The method disclosed herein further includes applying the catalyst slurry onto a substrate, followed by drying.

Particular examples of the substrate may include supports, such as carbon cloth or carbon paper, but are not limited thereto. More particularly, at least one polymer film selected from the group consisting of polytetrafluoroethylene (PTFE), perfluoroalkoxy (PFA), fluorinated ethylene propylene (FEP), polyvinylidene fluoride (PVdF), polypropylene (PP), polyimide (PI), polyethylene (PE), polycarbonate (PC) and polyethylene terephthalate (PET), or a combination thereof may be used as the substrate. The polymer film may include glass fibers or aluminum foil.

The polymer film may be a non-porous film or a porous film. In the case of a porous substrate, the substrate may have a pore size of 50 nm-100 μm and a porosity of 5-90%. The polymer film used as the substrate may have a thickness of 10 μm-1 mm.

The catalyst slurry may be applied onto the substrate, for example, by any one process selected from the group consisting of spray coating, screen printing, tape casting, brushing and slot die casting processes, but is not limited thereto.

The substrate coated with the catalyst slurry may be vacuum-dried. For example, the catalyst slurry may be dried at a temperature of 20 to 60° C. When producing a membrane-electrode assembly under the above-mentioned drying condition, it is possible to improve the porosity of the membrane-electrode assembly, resulting in a decrease in mass transfer resistance of an electrode.

After the operation of applying the catalyst slurry onto the substrate, the method disclosed herein includes transferring the substrate to either surface or both surfaces of an electrolyte membrane to form a catalyst layer.

The transferring operation may be carried out, for example, by stacking the substrate onto an electrolyte membrane, followed by hot pressing. In one exemplary embodiment, a hot press may be operated at a heating temperature of 100 to 140° C. under a pressure of 100 to 200 kgf/cm².

There is no particular limitation in the selection of the electrolyte membrane. For example, the electrolyte membrane may include at least one selected from the group consisting of perfluorosulfonic acid polymers, perfluorocarbon sulfonic acid polymers, hydrocarbon-based polymers, polyimides, polyvinylidene fluorides, polyether sulfones, polyphenylene sulfides, polyphenylene oxides, polyphosphazenes, polyethylene naphthalates, polyesters, doped polybenzimidazoles, polyether ketones, polysulfones, and acids or bases thereof. The electrolyte membrane may have a thickness of about 20 to 200 μm, particularly 40 to 60 μm.

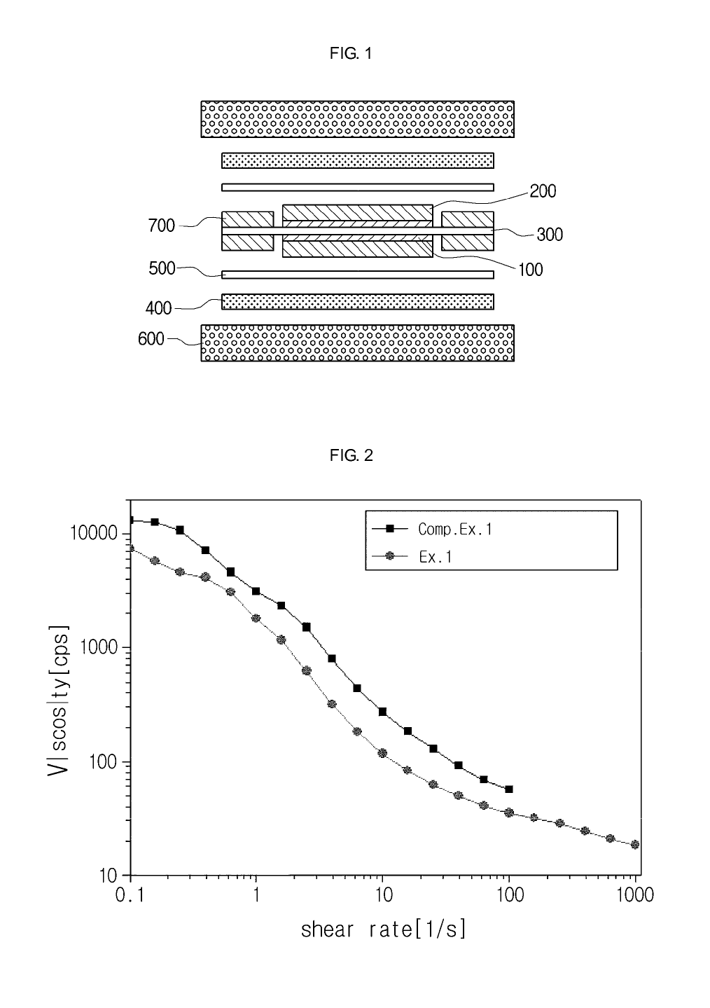

Particularly, the transfer of catalyst layer may be carried out by stacking a stainless steel plate 400, a gasket 500, catalyst ink slurry 100 coated on a substrate 200, Nafion 112 electrolyte membrane 300, a film 700 for fixing the electrolyte membrane and a hot pressing plate 600 in the structure as shown in FIG. 1, locating the resultant structure at the center of a hot pressing machine, and performing hot pressing for about 4 minutes.

After transferring the catalyst layer, the method may further include:

dipping the substrate, the catalyst layer and the electrolyte membrane obtained after the preceding operation into liquid nitrogen; and

removing the substrate to provide an electrolyte membrane having the catalyst layer formed thereon.

Particularly, incorporation of the operation of dipping the substrate, the catalyst layer and the electrolyte membrane obtained after the preceding operation into liquid nitrogen into the method disclosed herein allows one to carry out the transferring operation at a lower pressure and temperature as compared to the pressure and temperature used in conventional processes for producing a membrane-electrode assembly, while not adversely affecting the electrolyte membrane.

In an exemplary embodiment, when carrying out the dipping operation, the structure as shown in FIG. 1 is cooled, the stainless steel plate 400 and the gasket 500 are removed, and then the remaining structure including the electrolyte membrane (the catalyst ink slurry 100 coated on the substrate 200, Nafion 112 electrolyte membrane 300 and the film 700 for fixing the electrolyte membrane) is dipped into liquid nitrogen for 5-10 seconds. When the dipping operation is carried out for an excessively short time, it is not possible to obtain a sufficient transfer yield. On the other hand, an excessively long dipping time may adversely affect the electrolyte membrane.

In an exemplary embodiment, after the dipping operation, the substrate is removed. Herein, the film 700 for fixing the electrolyte membrane and the substrate 200 are removed from the structure dipped into liquid nitrogen in the preceding operation, thereby providing a membrane-electrode assembly having the catalyst layer formed on the electrolyte membrane. The resultant catalyst layer may have a thickness of 5-20 μm.

In another aspect, there is provided a membrane-electrode assembly obtained by the above-described method. It is possible to obtain a membrane-electrode assembly with a high catalyst transfer yield through the method disclosed herein, while not adversely affecting the quality of the electrolyte membrane.

In still another aspect, there is provided a fuel cell including the above-described membrane-electrode assembly. The fuel cell may include a polymer electrolyte membrane fuel cell (PEMFC).

### EXAMPLES

The examples will now be described. The following examples are for illustrative purposes only and not intended to limit the scope of the present disclosure.

### Example 1

First, 1 g (or 5.4 wt % based on the total dispersion) of a Pt/C catalyst and 0.43 g (or 2.31 wt % based on the total dispersion) of Nafion ionomer are dispersed into isopropanol (IPA) and water. The resultant dispersion is stirred at a temperature of 25° C. under a speed of 800 rpm, and then is subjected to sonication for 30 minutes at room temperature. Then, the dispersion is homogenized by using a homogenizer under 12000 rpm for 120 minutes. The resultant catalyst slurry is determined for its viscosity before and after the homogenization using a homogenizer. The results are shown in the following Table 1.

### Comparative Example 1

Catalyst slurry is provided in the same manner as described in Example 1, except that stirring of the catalyst slurry is not performed, and the viscosity of the catalyst slurry is determined. The results are shown in the following Table 1.

TABLE 1

After loading catalyst
Viscosity (cps)

| | Before homogenization | After homogenization |
|---|---|---|
| Example 1 | 11 | 110 |
| Comparative | 87.1 | 271.7 |
| Example 1 | | |

Once the homogenization operation is carried out, the catalyst slurry undergoes an increase in viscosity as the nano-sized Pt catalyst of several tens nanometers is combined with ionomers and the particles grow to a size of several hundreds nanometers. However, as can be seen from Table 1, Example 1 shows significantly lower viscosity as compared to Comparative Example 1, even after the homogenization. This suggests that catalyst and ionomer particles are dispersed homogeneously. Therefore, such additional stirring operation allows the particles to maintain a highly dispersed state, thereby providing significantly lower viscosity.

### Example 2

The catalyst slurry obtained from Example 1 is coated on a substrate (filter paper or polyimide film) via a Decal process and the coated substrate is dried in a vacuum oven at 25° C. for 24 hours. Before carrying out transferring the coated substrate to an electrolyte membrane, the total coating weight is measured. The results are shown in the following Table 2.

### Comparative Example 2

The catalyst slurry obtained from Comparative Example 1 is coated and dried in the same manner as described in Example 2. Before carrying out hot pressing to transfer the coated substrate to an electrolyte membrane, the total coating weight is measured. The results are shown in the following Table 2.

TABLE 2

| | | Example 2(after | Comparative Example |
|---|---|---|---|
| | | additional stirring | 2(Before additional |
| | | operation) | stirring operation) |
| Before hot pressing | Cathode | 0.2058 g | 0.2306 g |
| (weight of | Anode | 0.2013 g | 0.2042 g |
| substrate + | | | |
| catalyst) | | | |
| Amount of catalyst | Cathode | 0.361424 | 0.3652964 |
| transferred to | Anode | 0.283976 | 0.2930116 |
| membrane | | | |
| mg(Pt/C)/cm² | | | |

| | | |
|---|---|---|
| Viscosity (cps) | 110 | 271.1 |

It can be seen from Table 2, when comparing the weight distribution of Example 2 with that of Comparative Example 2, coating the catalyst slurry that has been subjected to dispersion operation on the substrate provides a more uniform coating state than the same catalyst slurry that has not been subjected to stirring.

### Example 3

The catalyst slurry of Example 1 and that of Comparative Example 1 are determined for viscosity by using a rheometer while the catalyst slurry is subjected to modification under an increasing shear rate. The results are shown in FIG. 2.

It can be seen from FIG. 2 that as the shear rate increases, the catalyst slurry obtained from the conventional method (Comparative Example 1) shows a decrease in viscosity while maintaining its unique structural arrangement, i.e., has shear-thinning characteristics. On the contrary, Example 1 shows a significantly decreased viscosity behavior, thereby preventing particle agglomeration or settling in the slurry and formation of a non-homogeneous mixture.

### Examples 4 and 5

1. Preparation of Catalyst Slurry

Pt/C catalyst ink slurry is prepared by using the composition as shown in the following Table 3.

TABLE 3

| Constituents | Unit (g) |
|---|---|
| Pt/C (45.5 wt %, Tanaka) | 1.0000 g |
| Deionized water (D.I.W.) | 9.5000 g |
| Nafion dispersion (EW 1100)- Total | 2.0500 g |
| Nafion ionomer | 0.4305 g |
| 1-propanol | 0.9020 g |
| Water | 0.7175 g |
| Isopropyl alcohol (IPA) | 7.4000 g |
| Solid content | 7.17 |
| Ratio of IPA/water + D.I.W. | 0.8125 |

To a 25 mL vial, 1 g of Pt/C (45.5 wt %, Tanaka) is introduced.

Next, 9.5 g of D.I.W. is added thereto.

Then, 7.4 g of IPA is further added thereto.

The vial is sealed with its cover and ultrasonication is carried out at room temperature for 10 minutes.

Then, 0.4305 g of Nafion ionomer (21 wt % based on the total dispersion) is dispersed into 0.9020 g of 1-propanol and 0.7175 g of water, while 2.05 g of dispersion of Nafion ionomer (EW 1100) obtained by adding 7.4000 g of IPA (wherein the ratio of IPA/water+D.I.W. is 0.8125 and the solid content, i.e. the ratio of combined weight of the catalyst and Nafion ionomer/combined weight of water and IPA is 7.17) is added thereto.

The vial is sealed with its cover and ultrasonication is carried out at room temperature for 10 minutes.

The contents of the vial containing Pt/C catalyst ink slurry are mixed by using a homogenizer. Herein, the homogenizer is maintained under a speed of 13,000 rpm for 120 minutes, and a circulator is used so that the internal temperature of Pt/C catalyst ink slurry may be maintained at a constant level during stirring.

2. Coating and Drying

After the completion of the stirring, Pt/C catalyst ink slurry is coated on a Kapton film (polyimide film available from Dupont) cut into an adequate size and having a thickness of 50 μm by using a doctor blade. Then, the Kapton film coated with Pt/C catalyst ink slurry is dried in a vacuum oven at 30° C. under vacuum of 760 mmHg for 24 hours.

3. Hot Pressing and Formation of Catalyst Layer

As shown in FIG. 1, a stainless steel plate (11 cm×11 cm), a film for fixing an electrolyte membrane (5 μm, Kapton film), a gasket (11 cm×11 cm), a catalyst layer bonded to a substrate (5 cm×5 cm) and a Nafion 112 electrolyte membrane (11 cm×11 cm) are stacked successively, and the resultant structure is located on the center of a hot pressing machine heated to 140° C. and is subjected to hot pressing under a pressure of 160 kgf/cm² for 4 minutes. After cooling the structure to room temperature, the stainless steel plate and the gasket are removed. Then, the Nafion 112 electrolyte membrane, the catalyst layer bonded to the substrate and the film for fixing the electrolyte membrane are dipped into liquid nitrogen for about 10 seconds. Finally, the film for fixing the electrolyte membrane and the substrate are removed therefrom to provide Examples 4 and 5 having a catalyst layer with a thickness of 10 μm or less.

### Comparative Examples 3 and 4

The process as described above is repeated, except that the upper and lower fixing films and the substrate are removed without any treatment with liquid nitrogen as described in Examples 4 and 5, thereby providing Comparative Examples 3 and 4.

### Test Example 1

Determination of Transfer Yield

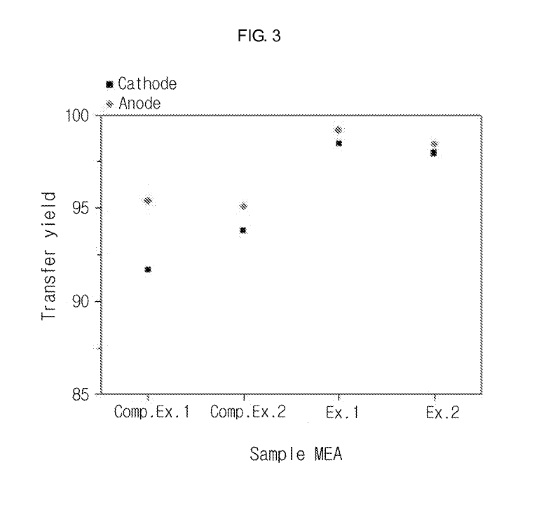

The transfer yields of Examples 4 and 5 and those of Comparative Examples 3 and 4 are calculated according to the following Formula 1. The results are shown in the following Table 4 and FIG. 3.

TABLE 4

| | | | | Transfer yield | | |
|---|---|---|---|---|---|---|
| | | | | Before hot | | |
| | | | | pressing | After hot | |
| | | | | (electrode | pressing | |
| | | | | layer | (electrode | Transfer |
| | Pt loading (mg/cm2) | | | weight, | layer weight, | yield |
| | Cathode | Anode | | g) (1) | g) (2) | (%) |
| Comp. | 0.3504 | 0.3412 | Cathode | 0.0300 | 0.0275 | 91.67 |
| Ex. 3 | | | Anode | 0.0281 | 0.0268 | 95.37 |
| Comp. | 0.3465 | 0.3210 | Cathode | 0.0290 | 0.0272 | 93.79 |
| Ex. 4 | | | Anode | 0.0265 | 0.0252 | 95.09 |
| Ex. 4 | 0.3198 | 0.3032 | Cathode | 0.0255 | 0.0251 | 98.43 |
| | | | Anode | 0.0240 | 0.0238 | 99.17 |
| Ex. 5 | 0.3072 | 0.3253 | Cathode | 0.0243 | 0.0238 | 97.84 |
| | | | Anode | 0.0256 | 0.0252 | 98.44 |

Transfer yield (%)=Electrode layer weight in the membrane after hot pressing/Electrode layer weight in the membrane before hot pressing×100 [Formula 1]

As can be seen from Table 4 and FIG. 3, Examples 4 and 5 provide a significantly transfer yield as compared to Comparative Examples 3 and 4.

### Test Example 2

### Determination of Effect of Liquid Nitrogen Treatment Upon Electrolyte Membrane

To determine the effect of liquid nitrogen treatment upon the electrolyte membrane, FT-IR analysis and ion conductivity measurement are carried out.

(1) FT-IR Analysis

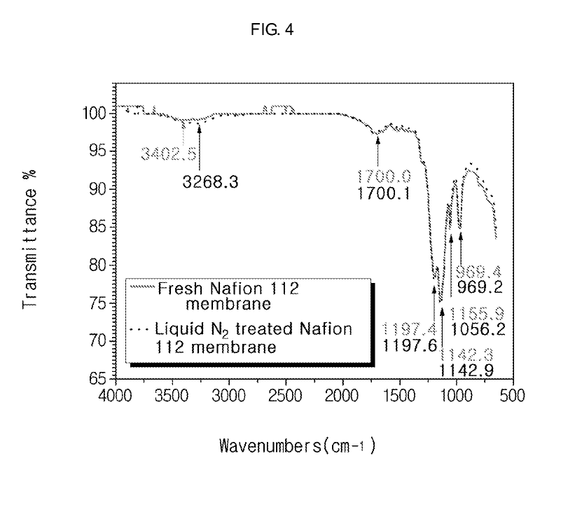

An electrolyte membrane not treated with liquid nitrogen (Nafion 112, Dupont: fresh Nafion 112 membrane in FIG. 4) and another electrolyte membrane treated with liquid nitrogen (Nafion 112, Dupont; N₂ treated Nafion 112 membrane in FIG. 4) are subjected to FT-IR analysis. The results are shown in FIG. 4.

(2) Measurement of Ion Conductivity

An electrolyte membrane not treated with liquid nitrogen (Nafion 112, Dupont) and another electrolyte membrane treated with liquid nitrogen (Nafion 112, Dupont) are determined for their ion conductivities by using three samples for each membrane. Each membrane is cut into a size of 3 cm×1 cm, swelled in D.I.W for 24 hours, and is subjected to measurement of impedance. Then, ion conductivity is calculated according to the following Formula 2. The results are shown in the following Table 5.

TABLE 5

| | Ion conductivity, σ (S/cm) | | |
|---|---|---|---|
| Sample | 1st | 2nd | 3rd |
| Nafion 112 electrolyte | 0.124 | 0.172 | 0.150 |
| membrane not treated with | | | |
| liquid nitrogen | | | |
| Nafion 112 electrolyte | 0.140 | 0.153 | 0.171 |
| membrane treated with liquid | | | |
| nitrogen | | | |

$$Ion conductivity = \frac{l ( cm )}{R ( Ω ) \times A ( {cm}^{2} )} \qquad [ Formula 2 ]$$

As can be seen from FIG. 4 and Table 5, there is no significant effect of liquid nitrogen treatment upon the quality of electrolyte membrane (deformation of the membrane and a change in ion conductivity).

### Test Example 3

### Evaluation of Performance of Unit Cell

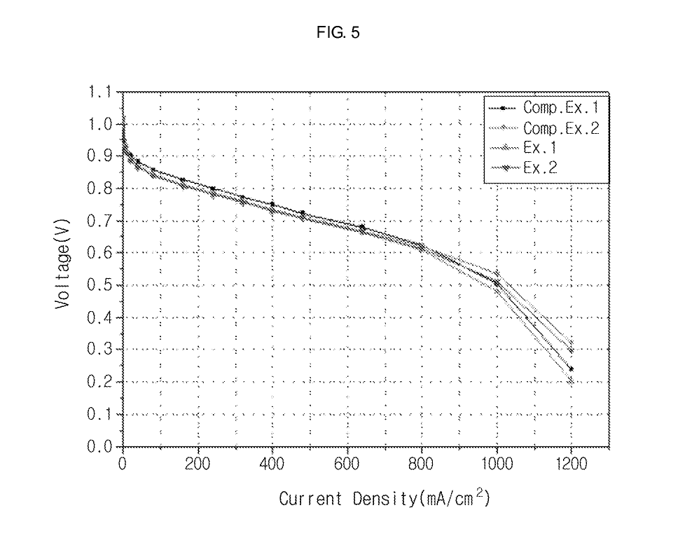

The MEAs obtained according to Examples 4 and 5 and Comparative Examples 3 and 4 are used to evaluate the performance of a unit cell. The results are shown in FIG. 5.

The performance evaluation is carried out under the conditions of a humidifier temperature of 71° C., a line heater temperature of 81° C. and a dew point of 64.3° C. at an anode, and a humidifier temperature of 69° C., a line heater temperature of 79° C. and a dew point of 64.5° C. at a cathode. The evaluation is carried out under a relative humidity of 100% in a constant current mode.

As can be seen from FIG. 5 illustrating polarization curves, the unit cell using a membrane electrolyte assembly subjected to liquid nitrogen treatment shows performance similar to the performance of a unit cell using no liquid nitrogen treatment.

According to the method for producing a membrane electrode assembly disclosed herein, it is possible to provide catalyst slurry including catalyst and conductive binder particles dispersed homogeneously therein, and to prevent an inconsistent increase in viscosity of slurry caused by particle agglomeration. Therefore, it is possible to form a catalyst layer having excellent uniformity after applying the catalyst slurry. Ultimately, membrane electrode assemblies using the catalyst layer provide improved performance. In addition, it is possible to provide a membrane-electrode assembly having an improved transfer yield of catalyst from a substrate to an electrolyte membrane while not adversely affecting the quality of the electrolyte membrane. Since the catalyst of a fuel cell uses an expensive noble metal catalyst, such an improved catalyst transfer yield may contribute to cost reduction in manufacturing fuel cells.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method for producing a membrane electrode assembly for a fuel cell, comprising:
dispersing a catalyst and a conductive binder into a dispersion solvent to provide catalyst slurry;
subjecting the catalyst slurry to stirring, sonication and homogenization;
applying the catalyst slurry onto a substrate, followed by drying; and
transferring the substrate coated with the catalyst slurry to either surface or both surfaces of an electrolyte membrane to form a catalyst layer.

2. The method for producing a membrane electrode assembly for a fuel cell according to claim 1, which further comprises:
dipping the substrate, the catalyst layer and the electrolyte membrane obtained after said transferring into liquid nitrogen; and
removing the substrate to provide an electrolyte membrane having the catalyst layer formed thereon.

3. The method for producing a membrane electrode assembly for a fuel cell according to claim 1, wherein said dispersing a catalyst and a conductive binder provides catalyst slurry comprising 3 to 10 wt % of catalyst, 1 to 5 wt % of conductive binder and 75 to 96 wt % of a dispersion solvent based on the total weight of the catalyst slurry.

4. The method for producing a membrane electrode assembly for a fuel cell according to claim 1, wherein the dispersion solvent in said dispersing a catalyst and a conductive binder is at least one selected from the group consisting of isopropanol, n-propanol, ethanol, methanol, water and n-butyl acetate.

5. The method for producing a membrane electrode assembly for a fuel cell according to claim 1, wherein said stirring catalyst slurry is carried out at 500 to 1000 rpm.

6. The method for producing a membrane electrode assembly for a fuel cell according to claim 1, wherein the substrate is at least one polymer film selected from the group consisting of polytetrafluoroethylene (PTFE), perfluoroalkoxy (PFA), fluorinated ethylene propylene (FEP), polyvinylidene fluoride (PVdF), polypropylene (PP), polyimide (PI), polyethylene (PE), polycarbonate (PC) and polyethylene terephthalate (PET), or a combination thereof.

7. The method for producing a membrane electrode assembly for a fuel cell according to claim 1, wherein said applying the catalyst slurry onto a substrate is carried out by any one process selected from the group consisting of spray coating, screen printing, tape casting, brushing and slot die casting processes.

8. The method for producing a membrane electrode assembly for a fuel cell according to claim 1, wherein the electrolyte membrane comprises at least one selected from the group consisting of perfluorosulfonic acid polymers, perfluorocarbon sulfonic acid polymers, hydrocarbon-based polymers, polyimides, polyvinylidene fluorides, polyether sulfones, polyphenylene sulfides, polyphenylene oxides, polyphosphazenes, polyethylene naphthalates, polyesters, doped polybenzimidazoles, polyether ketones, polysulfones, and acids or bases thereof.

9. The method for producing a membrane electrode assembly for a fuel cell according to claim 1, wherein said transferring is carried out by locating a film for fixing an electrolyte membrane on either surface or both surfaces of the electrolyte membrane and fixing the electrolyte membrane with the film for fixing an electrolyte membrane.

10. The method for producing a membrane electrode assembly for a fuel cell according to claim 1, wherein said transferring is carried out by stacking the substrate coated with the catalyst slurry onto an electrolyte membrane, and by performing hot pressing at a heating temperature of 100 to 140° C. under a pressure of 100 to 200 kgf/cm².

11. The method for producing a membrane electrode assembly for a fuel cell according to claim 1, wherein the substrate having the catalyst layer formed thereon after said transferring is vacuum-dried.

12. The method for producing a membrane electrode assembly for a fuel cell according to claim 2, wherein said dipping is carried out by dipping the substrate, the catalyst layer and the electrolyte membrane into liquid nitrogen for 5-10 seconds.

13. The method for producing a membrane electrode assembly for a fuel cell according to claim 2, wherein the catalyst layer formed on the electrolyte membrane after said removing the substrate has a thickness of 5-20 μm.
